(19) United States
(12) Patent Application Publication
(10) Pub. No.: US 2015/0371749 A1
(43) Pub. Date: Dec. 24, 2015

(54) UNCONTROLLED ALTERNATING-CURRENT DEMAGNETISER

(71) Applicants: Albert MAURER, JR., Grut (CH); Marek Rohner, Zurich (CH); Boris Ziegenhagen, Unterottikon (CH)

(72) Inventors: Albert MAURER, JR., Grut (CH); Marek Rohner, Zurich (CH); Boris Ziegenhagen, Unterottikon (CH)

(21) Appl. No.: 14/749,350

(22) Filed: Jun. 24, 2015

(30) Foreign Application Priority Data
Jun. 24, 2014 (CH) 00957/14

(51) Int. Cl. H01F 13/00

(52) U.S. Cl. CPC H01F 13/006

(57) ABSTRACT

For an uncontrolled alternating-current demagnetiser (1), comprising an alternating-current circuit (10) and an AC voltage source (100), wherein the alternating-current circuit (10) allows the AC voltage loading, by means of the actuation of a switch (S), of a parallel resonant circuit (P) comprising a demagnetising coil (L) and a parallel capacitor (C1) connected in parallel to the demagnetising coil (L), the option should be created to minimise the error proneness during demagnetisation, even of users, who do not have any knowledge of the processes during the demagnetisation. This is achieved in that the alternating current in the inductance L freely decays when the semiconductor element D is switched off. To limit the inrush current owing to the parallel capacitor C1, at least one electronic component (D) is arranged in series to the AC voltage source (100) and can be operated by means of switch (S). The alternating-current circuit (10) is in this case switched on exactly at the zero passage of the AC voltage source (100). A series capacitor (C2) is expediently connected in series with the demagnetising coil (L) in the alternating-current circuit (10).

### TECHNICAL FIELD

The present invention describes an uncontrolled alternating-current demagnetiser, comprising an alternating-current circuit and an AC voltage source, wherein the alternating-current circuit allows the AC voltage loading, by means of the actuation of a switch, of a parallel resonant circuit comprising a demagnetising coil and a parallel capacitor connected in parallel to the demagnetising coil.

### PRIOR ART

For a long time, uncontrolled alternating-current demagnetisers have been used for demagnetising ferromagnetic components or components with ferromagnetic contents.

An alternating current flow through at least one inductance is created by means of an AC voltage, which conventionally alternates with network frequency, and, as a result, an alternating magnetic field is created in the surroundings of the inductance. In order to create satisfactorily high alternating magnetic fields, the uncontrolled alternating-current demagnetiser must be designed in such a manner that a current flow of a few amperes can safely flow through the at least one inductance. The uncontrolled alternating-current demagnetisers, which can mostly be obtained in the form of plate demagnetisers or handheld demagnetisers, can be operated manually and are conveniently designed, a simple electronic circuit being used. The alternating AC voltage can be switched on and off easily by means of a switch, whereby after switching on, the AC voltage is applied in an uncontrolled manner at the at least one inductance and the correspondingly alternating magnetic field is induced until switching off. During operation, the magnetic alternating field has a defined amplitude and a constant frequency, defined by the applied AC voltage.

The at least one inductance in the form of a correspondingly designed coil is usually magnetically coupled with C/E cores made from ferromagnetic material. To increase the magnetic field action, the coils can be covered with plates, as a result of which the coil is also protected. The plates can in each case also be provided with a special coating, so that a sliding of the components over the plates can take place virtually frictionlessly.

In the technically simplest case of the configuration of a plate demagnetiser or a handheld demagnetiser, a parallel resonant circuit is used, which comprises a parallel capacitor and a demagnetising coil. After exciting the parallel resonant circuit and switching off the supply with AC voltage, this resonates, whereby the current amplitude automatically decays to zero and therefore a magnetic alternating field with decreasing amplitude can be created simply without control. As described in U.S. Pat. No. 2,240,749, the parallel resonant circuit is loaded with an AC voltage after a switch is switched on, as a result of which the demagnetising process can be started.

Whilst the electrotechnical construction of both uncontrolled demagnetisers is identical, the use is different. However, in both cases, a relative movement of the component to be demagnetised relative to the demagnetiser is generated.

After switching on the plate demagnetiser, a component to be demagnetised is moved over the plate surface of the plate demagnetiser manually or for example by means of a transport device, wherein the component is moved into the field lines and back out of the same. For the best possible demagnetisation, this should take place by means of approach towards the plate demagnetiser, brushing the plate as perpendicularly as possible to the pole transition of the C or E core demagnetising coil and removal as far as possible of the component from the plate and therefore from the region of the magnetic field lines. If the demagnetising method is carried out in this manner, optimum demagnetisation results can be achieved. In reality, the process looks different as part of a production process. Due to a runout section of the components away from the plate demagnetiser, which is too small, residual magnetic fields remain in the component to some extent. Also, it is conventional to switch off the plate demagnetiser already, although the component has not yet been removed from the region of the magnetic field lines. As this erroneous treatment of the component cannot be seen and often there are no magnetic field measuring devices present for investigating the demagnetisation, these errors remain undiscovered.

If a handheld demagnetiser is used, in the optimum case, the same is guided onto a component to be demagnetised after switching on, then moved at a minimum distance as evenly as possible over the surface of the component, and the handheld demagnetiser is subsequently continuously removed from the component. Owing to the high magnetic alternating field, a continuous movement with as constant a distance as possible from the component is often not easily possible. The handheld demagnetiser is to some extent technically bonded securely on the surface of the component and can only be moved jerkily. To make things easier, the handheld demagnetiser is simply switched off, in order to move the same away from the surface. Here also, undesired residual magnetic fields remain in the component.

The component appears demagnetised, as the demagnetising process is carried out from switching on up to switching off. The resulting disruptive residual magnetic field is generally higher however than before the demagnetising process is carried out. In production, the demagnetising process must be carried out quickly and as the responsible persons often have no idea of the processes during the demagnetisation, components with strong residual magnetism result.

In order to create an assured demagnetisation of ferromagnetic components, the prior art has moved away from uncontrolled alternating-current demagnetisers to more complex electronically controlled automated demagnetising devices. These are substantially more expensive and of more complicated construction, but offer the user the option of passing through a controlled demagnetisation curve after placing the component to be demagnetised. In this case, the alternating magnetic field is regulated down in a controlled manner, whereby a residual magnetism can be achieved within the component, which is lower than the strength of the Earth's magnetic field. Premium controlled demagnetisers are exceptionally simple to operate, which is why errors during demagnetisation are virtually excluded.

For some applications and for many users, the purchase of such a controlled automated demagnetising device is too expensive, however, and the procurement costs are shied away from, to the detriment of quality.

This circuit can also be used for demagnetising coils, e.g. tunnel demagnetisers, which do not have a coupling via an additional ferromagnetic laminated core. The parts to be demagnetised in this case produce the magnetic coupling alone. The parts for demagnetisation are in this case guided through or over the opening of the coil.

### DESCRIPTION OF THE INVENTION

The object of the present invention is to create simple and cost-effective uncontrolled alternating-current demagnetisers, using which the susceptibility to errors is minimised during demagnetisation, even by users who have no idea of the processes during demagnetisation.

The solution according to the invention can be integrated into conventional handheld, plate or tunnel demagnetisers with little additional outlay. The considerably more complicated and more expensive variant with external power modules or control devices for pulse/ramp control is therefore dispensed with.

Good process reliability is achieved by means of the uncontrolled alternating-current demagnetiser according to the invention, incorrect operation being minimised.

### SHORT DESCRIPTION OF THE DRAWINGS

A preferred exemplary embodiment of the subject of the invention is described in the following in connection with the attached drawings.

FIG. 1 shows a schematic view of an electronic circuit of an uncontrolled alternating-current demagnetiser according to the invention.

FIG. 2 shows the temporal curve of the alternating magnetic field amplitude during operation of the uncontrolled alternating-current demagnetiser in a schematic view during the switching on, network operation and switch-off phase, network operation being illustrated in a very abbreviated manner.

### DESCRIPTION

An uncontrolled alternating-current demagnetiser 1 is described, which can be used for carrying out an optimised, less error-prone demagnetisation process, even by lay persons.

The alternating-current demagnetiser 1 has an alternating-current circuit 10, which can be mounted in a housing 11. The alternating-current circuit 10 comprises a parallel resonant circuit P with a demagnetising coil L as inductance and a parallel capacitor C1 as capacitor. Both components are connected in parallel to one another. The demagnetising coil L consists of a plurality of windings, which are advantageously wound as closely as possible, so that high magnetic field strengths can be achieved and can have a cylindrical or rectangular design, depending on the embodiment. The parallel capacitor C1 is conventionally chosen as standard motor capacitor. Typical capacitances of the parallel capacitor C1 lie between 4 μF and 40 μF.

The parallel resonant circuit P is supplied by an AC voltage source 100 likewise arranged parallel to the demagnetising coil L and to the parallel capacitor C1, whereby an AC voltage with a constant frequency f and an AC voltage amplitude U_{AC} can be loaded by means of the AC voltage source 100. In this case, the AC voltage induces a current flow and a magnetic alternating field resulting therefrom in the demagnetising coil L during operation.

As no active regulation is required for uncontrolled alternating-current demagnetisers 1 and demagnetising methods carried out therewith, high requirements are not placed on the AC voltage source 100. In the simplest case, the frequency f can be the network frequency 50 Hz or 60 Hz, whilst the alternating amplitude should be constant.

The alternating-current circuit 10 is realised in a switchable manner by a switch S, the AC voltage being applied at the parallel resonant circuit when the switch S is switched on.

For demagnetisation, the alternating current circuit 10 is loaded with the AC voltage by switching on the switch S. A magnetic alternating field is built up in the region of the demagnetising coil L. Components to be demagnetised 13 are subsequently guided along a plate side 12 on the demagnetiser or the demagnetiser is guided past the components 13 to be demagnetised. The components 13 to be demagnetised dip into the magnetic alternating field in this case and are then removed from the magnetic alternating field, demagnetised components 14 then resulting virtually without a residual magnetic field.

The invention is based on the idea of minimising incorrect operation during the demagnetising process by means of circuit-engineering-based measures and to increase the process reliability as a result.

Due to the arrangement of special circuit components or measures, it is prevented that current pulses or inconsistencies of the resulting alternating current lead to undesired magnetisation of the components to be demagnetised 13 when switching on and when switching off.

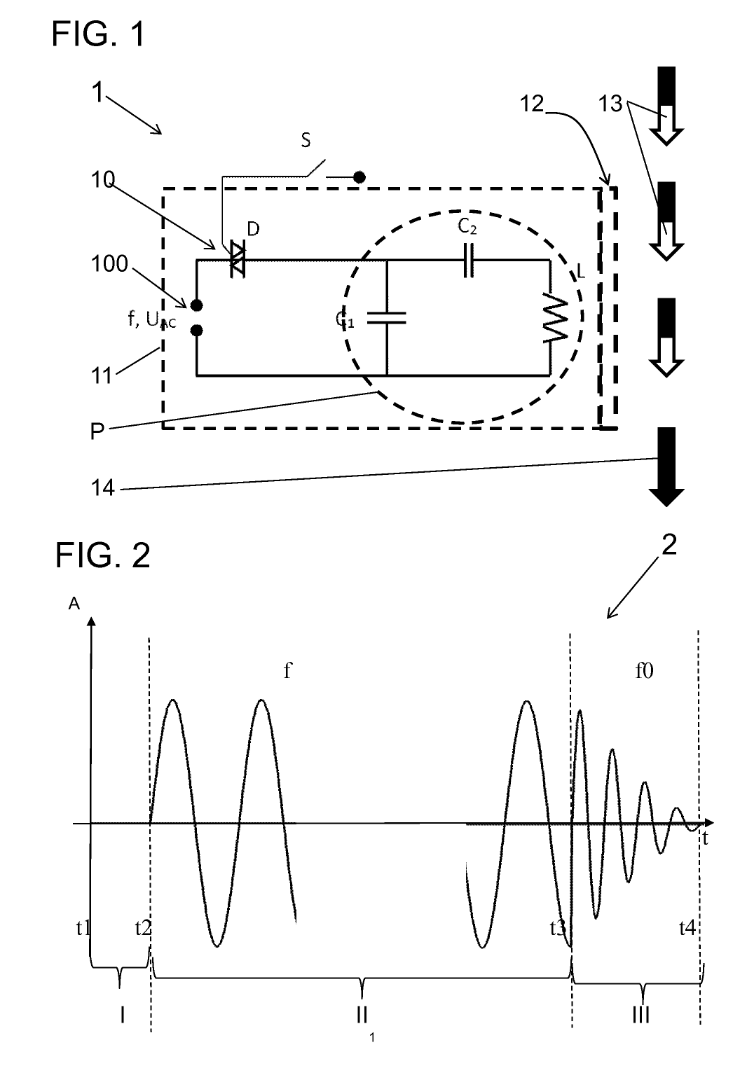

As can be seen in FIG. 1, a semiconductor component D is integrated into the alternating-current circuit 10, which is connected in series with the AC voltage source 100 and can be actuated by means of the switch S. Preferably, the semiconductor component D is a triac, using which, the alternating current in the alternating-current circuit 10 can be switched on in a controlled manner, preventing an inrush current pulse. Accordingly, the semiconductor component D is an inrush-current-limiting semiconductor component D, which switches the alternating current in zero passage, which is why a high inrush current, which would result owing to the parallel capacitor C1, is prevented in the alternating-current circuit 10. Therefore, an early failure of the semiconductor module D or a conventional switch, which can be used alternatively, owing to the high inrush currents is prevented.

In order to prevent an undesired magnetisation of components to be demagnetised 13 when switching off the uncontrolled demagnetiser 1, a series capacitor C2 is connected in series to the demagnetising coil L and therefore arranged within the parallel resonant circuit P. The series capacitor C2 prevents a current breakdown, which can occur during operation of the uncontrolled demagnetiser 1 due to the manipulation of the inductance of the demagnetising coil L by means of approach towards demagnetising ferromagnetic components 13. Preferably, the series capacitor C2 is a standard motor capacitor. Particularly preferably, parallel capacitor C1 and series capacitor C2 are configured identically.

On the basis of a switch-on and off spectrum 2, the temporal curve of a demagnetising process is explained on the basis of FIG. 2. In order to start a demagnetising process, the uncontrolled demagnetiser 1 is switched on at time t0 by means of switch S. Thus, a switch-on phase I begins. Owing to the semiconductor component D, the alternating-current circuit 10 is only loaded with the AC voltage U_{AC} in a time-delayed manner with respect to time t1 at the zero passage of the AC voltage U_{AC}, as a result of which the inrush current owing to the capacitor C1 is effectively limited and the switch-on phase I transitions to a network-operated phase II.

In the network-operated phase II, the AC voltage U_{AC} leads with a frequency f and defined amplitude to an alternating current in the alternating-current circuit 10 and an alternating magnetic field with a magnetic field amplitude A with frequency f induced in the demagnetising coil L. The component to be demagnetised is preferably only guided past the uncontrolled demagnetiser 1 in the region of the demagnetising coil L during the network-operated phase II, which usually lasts a few seconds.

After guiding past the component to be demagnetised 13 and successful demagnetisation, the switch S is thrown at a time t3, whereupon a switch-off phase III is started. The AC voltage U_{AC} is separated from the alternating-current circuit 10 and a decaying of the parallel resonant circuit P with takes place with the resonant frequency f0 of the parallel resonant circuit P to a magnetic field amplitude A of zero at a time t4. As indicated in FIG. 2, the resonant frequency f0 of the resonant circuit is greater than the excitation frequency f of the AC voltage U_{AC}.

Even if a component to be demagnetised 13 were to find itself still in the region of the demagnetising coil L during the switch-off phase III, no undesired magnetisation would take place, as an automatic decaying takes place. In this phase, the parallel resonant circuit is composed of C1, C2 and L.

Preferably, the AC voltage source 100 delivers a constant peak-peak AC voltage amplitude U_{AC} and the frequency f of the AC voltage can be set freely to a constant value in a frequency range of approximately 1 Hz to 100 Hz, so that the AC voltage source 100 can be set for the desired demagnetisation results at excitation frequencies f of 1 Hz to 100 Hz. In practice, the conventional power network is used as AC voltage source 100, which network delivers AC voltages with 50 Hz and 230 V or 60 Hz and 115 V.

Instead of a triac, the semiconductor component D can be formed from a plurality of thyristors, which are correspondingly wired. Preferably, two thyristors are connected anti-parallel to one another.

Experiments have shown that the capacitances of the capacitors C1 and C2, and the inductance of the demagnetising coil L should be chosen in such a manner that the resonant frequency f0 of the parallel resonant circuit P should lie above the network frequency of 50 Hz or 60 Hz, for example by a factor of 2 to 4 times.

### REFERENCE LIST

1 Uncontrolled alternating-current demagnetiser
10 Alternating-current circuit
   100 AC voltage source
   U_{AC} AC voltage
   f Excitation frequency (network frequency 50/60 Hz)
   f₀ Resonant frequency
   S Switch
   C₂ Series capacitor
   C₁ Parallel capacitor
   L Demagnetising coil (inductance)
   D Inrush-current-limiting semiconductor component
   P Parallel resonant circuit
11 Housing
12 Plate side
13 Component to be demagnetised
14 Demagnetised component

2 Switch-on and -off spectrum

A Magnetic field amplitude

t Time

I Switch-on phase

II Network-operated phase

III Switch-off phase

1. An uncontrolled alternating-current demagnetiser, comprising an alternating-current circuit and an AC voltage source,
wherein the alternating-current circuit allows the AC voltage loading, by means of the actuation of a switch, of a parallel resonant circuit comprising a demagnetising coil and a parallel capacitor connected in parallel to the demagnetising coil,
characterised in that
the alternating-current circuit has at least one electronic component arranged in series to the AC voltage source and can be operated by means of switch, using which the alternating-current circuit can be loaded with AC voltage in a manner defined exactly at zero passage of the AC voltage, as a result of which an inrush current pulse can be prevented,
and
has a series capacitor connected in series with the demagnetising coil in the alternating-current circuit.

2. The uncontrolled alternating-current demagnetiser according to claim 1, characterised in that the at least one electronic component is an inrush-current-limiting semiconductor component in the form of a triac.

3. The uncontrolled alternating-current demagnetiser according to claim 1, characterised in that a circuit with a plurality of thyristors is chosen as at least one electronic component, preferably a circuit with two thyristors connected anti-parallel to one another is chosen as inrush-current-limiting semiconductor component.

4. The uncontrolled alternating-current demagnetiser according to claim 1, characterised in that the capacitances of the parallel capacitor and the series capacitor, and the inductance of the demagnetising coil are chosen in such a manner that a resonant frequency of the parallel resonant circuit lies above the excitation frequency of the AC voltage for example by a factor of 2 to 4 times.

5. The uncontrolled alternating-current demagnetiser according to claim 1, characterised in that the series capacitor is a motor capacitor.

6. The uncontrolled alternating-current demagnetiser according to claim 1, characterised in that the parallel capacitor and the series capacitor are configured identically.
